(19) United States
(12) Patent Application Publication
(10) Pub. No.: US 2016/0140572 A1
(43) Pub. Date: May 19, 2016

(54) SYSTEM AND METHOD FOR DATA BREACH READINESS AND PREDICTION

(71) Applicant: CSR Professional Services, Inc., Jensen Beach, FL (US)

(72) Inventors: Warren Ross Federgreen, Jensen Beach, FL (US); Jenny Kim Heyns, Jupiter, FL (US)

(21) Appl. No.: 14/937,476

(22) Filed: Nov. 10, 2015

Related U.S. Application Data
(60) Provisional application No. 62/135,326, filed on Mar. 19, 2015.
(60) Provisional application No. 62/077,496, filed on Nov. 10, 2014.

(51) Int. Cl. G06Q 30/00; G06F 21/57; G06F 21/60

(52) U.S. Cl. CPC G06Q 30/018; G06F 21/604; G06F 21/57; G06F 2221/034

(57) ABSTRACT

A system for data breach readiness comprising computer executable code for presenting a questionnaire relating to data security practices; grading the answers to the questionnaire to determine a readiness score; presenting a task list comprising a list of tasks to be accomplished before a thresh hold readiness score is achieved; and presenting a user interface to update the task list to show that an entry in the task list has been completed.

### PRIORITY

This application claims the benefit of U.S. Provisional Application Ser. No. 62/135,326, filed Mar. 19, 2015, and U.S. Provisional Application Ser. No. 62/077,496, filed Nov. 10, 2014, the disclosures of which are incorporated herein by reference.

### BACKGROUND OF THE INVENTION

All commercial organizations deal with Personally Identifiable Information (“PII”), and therefore are required to comply with regulatory rule sets. Commercial organizations are, or should be, consistently reviewing their business process and procedures to ensure that they are protecting their data throughout the full data life cycle management (“DLCM”): acquisition, allocation, retention and destruction. However, designing processes and systems for these frequent reviews of processes and procedures can prove costly, and requires procedural expertise and substantive knowledge of statues, rules, and best practices. Accordingly, a product or service offering available to businesses in the small to middle market that is easy to use and cost effective is needed.

### SUMMARY OF THE INVENTION

A data breach readiness program in accordance with one aspect of the present invention provides this much-needed solution to the small to medium business marketplace. The Readiness program, in accordance with one aspect of the present invention, starts with a self-assessment questionnaire that evaluates the end user based on Gap Analysis Principles (“GAP”). The GAP covers a review of five domains that have been analyzed and determined to provide us with the best assessment of the end user's business processes in regards to DLCM.

Reponses to the domain questions generate tasks associated with correcting deficiencies, and then the program, in one aspect, presents offerings to help with remediation and provides risk scoring. Completing the tasks identified gives the user the ability to receive a certificate of completion.

The GAP was designed to be clear and concise to improve overall compliance. The GAP is divided into five domains: Policies, Compliance, Security, Incident Response Planning and Information Governance.

Each domain has, in one aspect, between 10 and 15 questions. The questions are purposefully written to be easy to understand, which drives completion and encourages the end user to provide answers that have a high reliability of accuracy. The information derived from Readiness responses increase the ability for data security services providers to gain market intelligence and insight on their customers, who are commercial organizations dealing with PII, e.g. retailers (sometimes referred to herein as “end users”). The information is usable and immediately actionable, allowing for numerous opportunities for up selling.

In one aspect, the system can be used to capture intelligence about commercial organizations. Marketing surveys are often ignored and do not encourage the end user to provide reliable answers. Customer Service surveys can be skewed as they are typically not answered unless the end user is very satisfied or very unsatisfied, therefore missing key feedback from a large percentage of clients.

In accordance with one aspect of the present invention, the readiness program can be used as an intelligence platform that encourages reliable answers as well as completion of the questionnaire. The end user wants to finish the questionnaire to understand the likelihood and mitigate the possibility of being breached. The real-time data that is captured can immediately be reviewed by both the data management service provider and the end user commercial organization. This not only provides the end user with needed offerings, but will also place these offerings on their remediation task list, reinforcing the need for the offering.

In accordance with one aspect of the invention the readiness questionnaire asks specific questions such as, “Do you have a record retention policy?” Answers to these specific questions allows the program to provide a score to the end user and usable intelligence to the data management service provider, who can then offer a records management program or services to those that answer “No.”

In accordance with one aspect of the present invention, the application can offer the capabilities for data management service providers to add custom questions to the questionnaire. These custom questions allow data management service providers to gain specific intelligence about their customers (e.g., commercial entities in possession of PII), which will allow them to market targeted products and services to their customers. Custom questions have the same level of customization and flexibility as standard GAP questions. Questions can be multiple choice or multi-select. They can range from standard Yes/No questions to “Select all that apply” questions. For instance, for a customer who answers yes to “Do you have a record retention policy?” there is a standard follow on question “Do you have a secure way to dispose of PII when you no longer need it?” A data management service provider could add an additional follow on question, asking what method(s) the customer uses for disposal and provide several options to choose.

Once the end user has started the GAP, it immediately provides the data management service provider with the capabilities to warehouse this data and review how their end users have answered specific questions. The end user does not have to complete the GAP for the data management service provider to start reviewing this valuable data. Through reports and notification services, the data management service provider can be aware of their client's needs immediately.

In accordance with one aspect of the invention, the readiness program will notify the data management service provider immediately when an end user has selected a specific answer to their custom questions. If the data management service provider wants to receive notifications when an end user selects, “No,” to the question, “Do you shred any documents that are no longer needed?” The program will send out a notification to the data management service provider making them aware that an end user is in need of additional shred services.

The ability to receive notifications while end users answer questions on the GAP empowers the data management service provider to market proactively and gain reliable actionable intelligence instantly.

Once an end user has completed their GAP, they will be presented with tasks that are required to be implemented and/or completed to receive a Readiness certificate of completion that is good for one year. The task list will present all the offerings based on the answers they selected. Remediation offerings that include customizable policies, best practices and a learning module can also be recommended and implemented.

End users will be required to confirm that they have resolved each remediation item on the task list before certification of completion is granted. Although it is not required that the end user purchase each of the recommended offerings, it will be required that the user confirms that they have completed the work necessary to remediate the issue discovered.

Data management service providers can display offerings associated with custom questions and presented on the end user's remediation task list. For instance, an end-user that does not safely store old documents could have on their task list to contact the data management service provider for secure storage options. This encourages the end user to contact the data management service provider to gain information on the recommended product or service. Offerings that are on the remediation task list will be perceived as offerings that need to be implemented to obtain certification.

In one aspect of the invention, the end-user must return to the branded site of the data management service provider to check off each item on their Readiness task list. Once an end user has completed their task list, they will be placed on a certified list of vendors that is available to the public. The public will be able to search for certified vendors based on location, service/product offering, name, etc. In one aspect of the intention, the certified list is published on an internet website, which can be searched by the public.

The certified list of vendors is an easy to use searchable database of certified vendors that have successfully completed Readiness. The certified vendor list, which can be accessed via a website, is a tool that consumers and vendors will use to search for partners and providers that can provide the services they need with the added confidence that they run their business following best practices around breach and data protection.

In accordance with one aspect of the intention, the program is designed as a continuous use product. This allows multiple exposures to the data management service provider's brand, as well as additional opportunities to sell products and services. Some customers will choose to return multiple times to complete the GAP analysis. Additionally, users will have to return to the site to verify completion of the items outlined on their task list to gain certification. To retain the certificate of completion and a position on the certified list of vendors, Readiness requires the customer to complete an annual review. Due to the annual administration of the GAP to ensure compliance, the data management service providers have an annual opportunity to ask a new set of customized questions to their end users and present any associated offerings to the end user based on their answers. The learning aspect of the invention stretches the reach down to the most granular level and becomes not only a valuable tool for the data management service provider but for the end user organization.

In accordance with one aspect, the readiness program provides data management service providers with the data that will help them make marketing decisions based on compliance and scoring. Additionally, reports will be sent to data management service providers that will detail the purchase history of the end users. All offerings, including custom offerings, will be listed on the report. This reporting provides data management service providers with an additional opportunity to connect with their clients based on the specific products that they purchase. If a client purchases a particular product, clearly the client recognizes a weakness in their program. The data management service providers can capitalize on this with a targeted communication directed to the client's indicated area of need.

In accordance with one aspect, the invention includes a predictive analysis platform for potential data breaches. Analysis is based on multiple factors such as actual breaches occurred, geographic location, domain score and actual answers to specific questions and/or groups of questions within the questionnaire. Questionnaires have custom level predictive factors that can be associated to one or more questions within a questionnaire. These factors, along with overall domain level scoring, allow the invention to provide a prediction on the likelihood a breach will occur, what type of breach, and what deficiency will cause that breach to occur.

In accordance with one aspect, the data management service providers have the ability to view the end user statistics at an individual end user level as well as across their entire end user population.

### BRIEF DESCRIPTION OF THE DRAWINGS

FIG. 1 is a flow chart of a method in accordance with one aspect of the present invention.

FIG. 2 is an exemplar of a questionnaire in accordance with one aspect of the present invention.

FIG. 3 is an exemplar of a task list in accordance with one aspect of the present invention.

FIG. 4 is an exemplar of a readiness completion summary in accordance with one aspect of the invention.

FIG. 5 is an exemplar of a “white list” of compliant entities, published on a website, in accordance with one aspect of the invention.

FIG. 6 is an exemplar of a widget that can be embedded in a third party website associated with an end user, in accordance with one aspect of the invention.

### DETAILED DESCRIPTION OF ASPECTS OF THE INVENTION

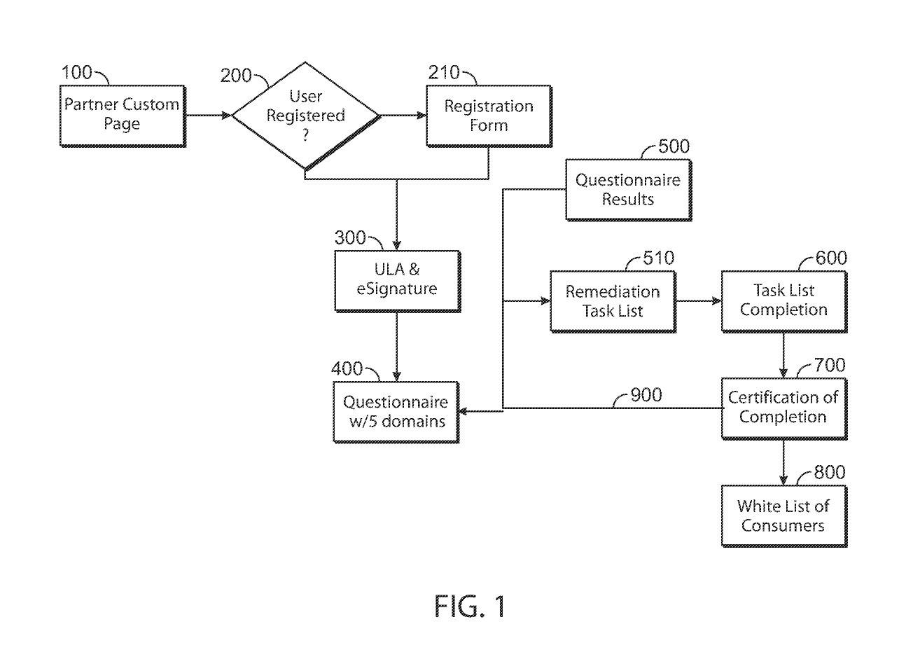

Turning now to FIG. 1, wherein a flow chart of a method in accordance with one aspect of the present invention is shown. The end user enters the system by entering a URL in an internet web browser. In accordance with one aspect of the invention, the URL is a custom URL that is provided to them by their data management service provider and contains text indicating the identity of the partner.

### Provider Setup

Each data management service provider has a site that allows their end user to access the system with a custom URL in step (100). In one aspect, the page is branded close to the provider's website/branding guidelines and is customized to their brand colors, logo and welcome content.

### Registration

In step (200) the end user is required to register on the system in order to complete the Gap Analysis Questionnaire, view and purchase products and review scoring and task lists. End users will experience two different views based on whether they have registered and logged in or have not. In step (210), the end user is presented with a registration form which, in one aspect, is simple and not time consuming. Only the necessary information is captured to ensure that user can begin their questionnaire. In accordance with one aspect, end users will only be able to log in through their respective data management service provider site. End users will be able to register across multiple data management service provider without causing any conflicts due to duplicate emails or end user information.

Once a registration form is submitted, user will be required to validate their account. The user will receive an email requesting that the account be confirmed. Once confirmed the user will be able to log into the system. A registration confirmation email will be sent out and user will required to review, accept and electronically sign an end-user license agreement (“EULA”) Once the user has entered in all required fields and submitted the registration form the following occurs:
1. User is automatically logged in
2. User is navigated to a confirmation page and encouraged to start their GAQ.
3. User will receive a confirmation registration email

### End User License Agreement

Once an end user completes and submits the registration form, they must read and accept the user license agreement in step (300) in order to complete the registration process. Once the EULA has been reviewed, accepted and e-signed, the user will be logged in. In one aspect, the EULA will be in a window that must be scrolled through before the accept button is active for selection. Once accepted a date/time stamp is saved. If a user does not accept the EULA they will be asked to accept before every attempted login until the end user has accepted the EULA.

### Login

On every partner home page, if an end user is not logged in, the user will be presented with the partner's home page with the ability to log in. The login box will require their email address and their password.

Once successfully logged in the system will recognize the user by presenting the following:
1. Welcome message (Welcome Bill)
2. My account link—allows user to update their profile and password
3. Navigation will update and display their Questionnaires, Task List, and/or Products, depending on the end user's usage and purchase history.

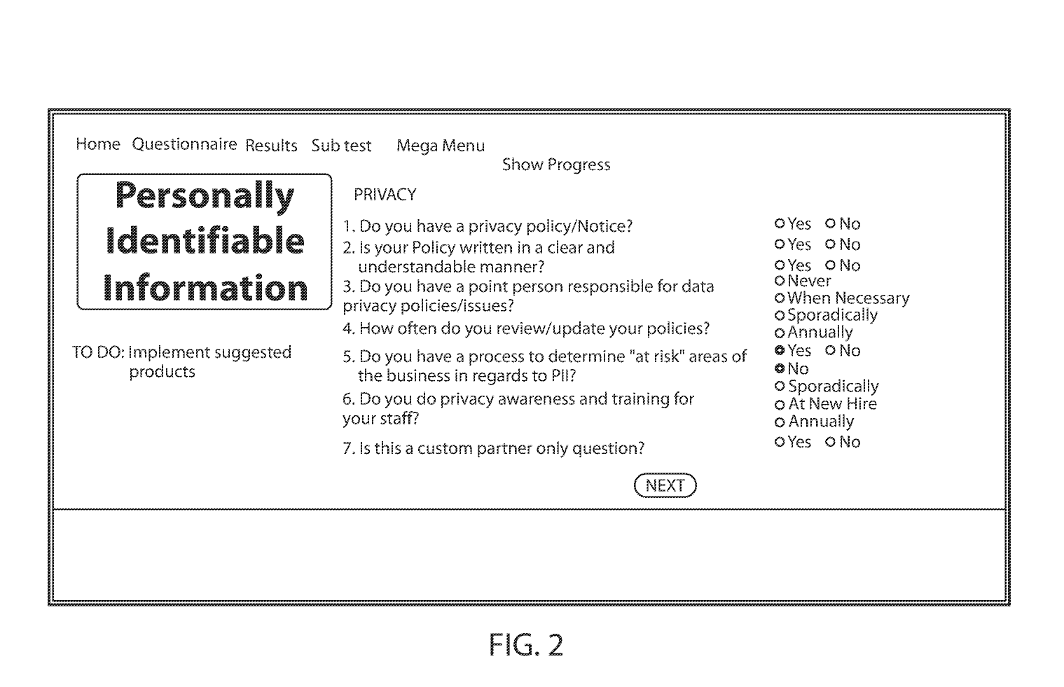

Registered users who are successfully logged into the system will have the ability to take a gap analysis questionnaire (GAQ) in step 400. In one aspect, he GAQ will be divided into multiple “domains” and within each domain; the end user is encouraged to answer all questions, however it will not be a requirement. An exemplar GAQ is shown in FIG. 2.

### Answering Scenarios

Turning back to FIG. 1, based on the answers the registered user will be presented with an assessment, recommended products and a task list that will identify the various tasks they are required to complete in order to receive their annual certification.

### USE CASES

If all questions are answered: Score is based on sum of all the weights of each answered question.

If fewer than all questions are answered and user has decided not to answer those questions not answered: All unanswered questions will be assessed a zero (0) score. Score is based on the sum of all the weights of each answered question.

### Domains

Domains are defined areas that categorize a group of questions together. Domains are database driven and therefore can be modified and added to through database entries. Currently defined domains are:

1. Privacy

2. Compliance

3. Security

4. Incident Response

5. Governance

Users are able to navigate to a different domain without answering all the questions within the respective domain. Upon final submission of the questionnaire they will be presented with the questions they have not answered, as well as, presented with the option to not answer the questions and submit the questionnaire for scoring and recommendations.

### Domain Scoring

Domains have custom scoring based on the questions that are associated to the domain. Each domain has a score for Excellent, Good, Satisfactory, or Unsatisfactory. Based on the users overall score the user is presented with an Excellent, Good, Satisfactory, or Unsatisfactory rating along with the recommended products.

### Domain Weights and Ratings

The system allows for weights and ratings to be associated to questions and answers. Based on the end user's answer, weight factors at question and answer level, a domain level score is calculated and presented back to the end user.

### Questions

GAQ questions are multiple choice. The multiple choice questions are highly customizable Answers can be customized, from “Yes” and “No” to any custom text that would provide a multiple choice answer. Questions weights determine the correctness of the answer. Each answer is associated a “weight”. There are two different types of weights. Weights and ratings can determine overall Domain Score and remediation tasks and offering associations. Questions have the ability to add conditional logic for displaying additional child/related questions. For example, if an end user selects “No” to a question, they will then be presented with another set of questions. If they select “Yes” it will skip questions and present the end users with the next set of appropriate questions.

In one aspect, the invention has the capacity to offer different questionnaires driven on regulatory body based on geographic location and size of company, offering a more sophisticated and detailed gap analysis for larger organizations with more depth and complexity. Each questionnaire will have its own predictive analysis logic that is based on multiple factors and user inputs.

Each questionnaire will calculate its own breach predictions based on the following factors:

1. Individual questionnaire and answers from one to many questions

2. Industry data breach information

3. Data breach information captured from Readiness end users

4. Region of organization

5. Readiness score at the domain level

The system will take these factors into consideration as well as have an intelligence advantage that will solidify or modify likely breach percentages and associations based on breach history and source of breach.

### Offerings

Products are documents that once purchased can be downloaded by the end user. Products have a many to many relationship to question ratings and is based on the logic of overall parent question score which is the sum of the parent and child answers. Weights are used for product association as well as providing an overall score to the end user for the respective domain.

While domain scoring is based on factors, weights, all selected answer ratings for questions within the respective domain. Product ratings will be based on a greater than or equal to model. Products can be associated to one or more questions/answers and each association has a scoring which will determine if a product should be recommended based on the less than values and greater than or equal to values associated.

Weights are applied to every answer while a scoring base is set at question level. Weights and factors are not equal across all questions, therefore not all questions score the same. Domain scoring is based on the overall average of each question score for a respective domain. Based on the overall percentage, a score of Excellent, Good, Marginal or Poor will be presented to the user.

Scoring also takes into consideration the harm risk of an incorrect answer. Solution is flexible to change with regulation change as well as take into consideration current breach issues increasing or decreasing the potential harm factor for each question.

### Domain Scoring and Task List

In step (500) the results are in and domain scoring is performed. Domain scoring is based on the total number of answer weights within the domain. Each domain has a score that “grades” the total domain score as, for example, Excellent, Good, Satisfactory and Unsatisfactory. Within each domain a remediation task list will be presented based on the calculation of answer scores.

### Results

Once a questionnaire is submitted by an end user, the questionnaire is automatically scored and results are presented back to the end user. Each domain score is presented and all recommended products are displayed next to each result based on the answers from the questionnaire. Products can be added to the user's cart from the results page, if desired.

### Task List

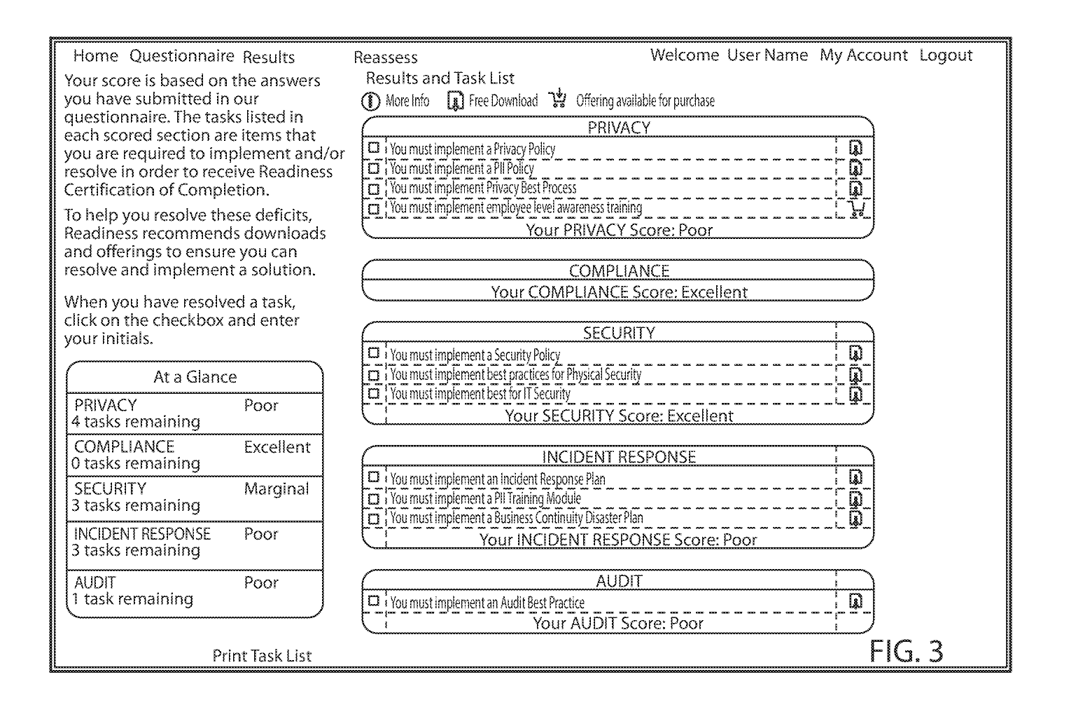

Once results and products are recommended, in step 510 a Remediation Task List is generated and associated to the questionnaire. The task list identifies all tasks that are required for the end user to complete in order to receive Readiness Certification. The task list will list all tasks necessary to comply with Readiness standards and associated products that will provide the end user with the requirements to complete tasks. An example of a Remediation Task List is shown in FIG. 3. Recommended product purchase is not required to complete the task list. Turning back to FIG. 1, the end user has the ability to identify that an item on the task list is completed in step (600). All items on the task list must be “checked off” in order for the end user to receive CSR Readiness Certification of Completion in step (700). The task list can include a predictive score for future breaches. The predictive score is based on initial gap analysis, regardless of remediation. Once the end users attests that they have remediated, they may or may not receive a different breach prediction. The system will make the final assessment and, if appropriate, present an after-remediation prediction.

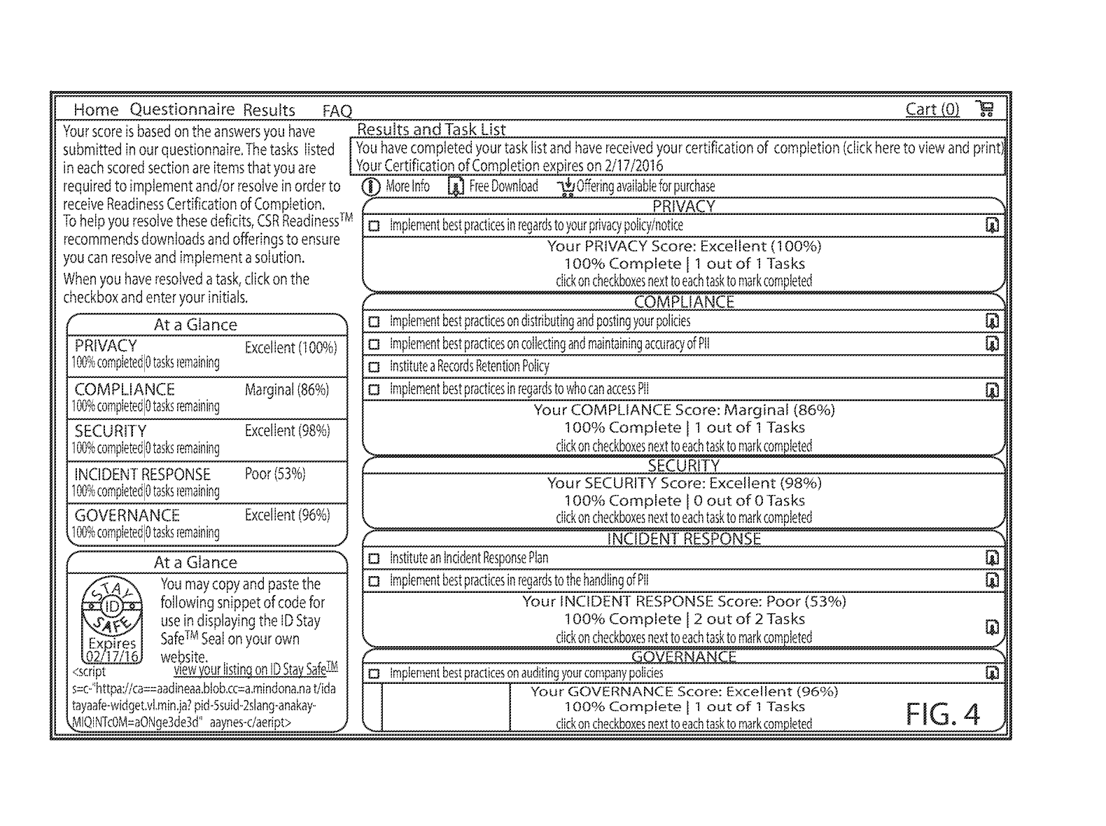

If the provider is still an active participant in the system, Readiness registered users are eligible for recertification each year in step 900. Recertification requires a complete GAP analysis questionnaire to be completed again. End users are able to take a GAQ annually. Once they receive certification 60 days prior to the expiration of their certification they are able to start a new GAQ. An exemplar of the website showing a readiness completion summary is shown in FIG. 4. In accordance with one aspect, the system will allow end users to take the GAP multiple times, providing a current assessment on data privacy and security. Each GAP completed will generate a task list with a predictive analysis of a potential of breach.

### List of Certified Vendors

Once end users complete their Readiness remediation task list they will be presented with a certification of completion. The certification of completion qualifies an end user's organization to be searchable and displayed on a list of certified vendors (a.k.a. a “white-list”) in step (800), which can be published on a website. The website containing the list of certified vendors provides opportunities for end users that have received the Readiness certification of completion with the opportunity to be available in searches based on product and service offering, zip code, industry commodity code, etc

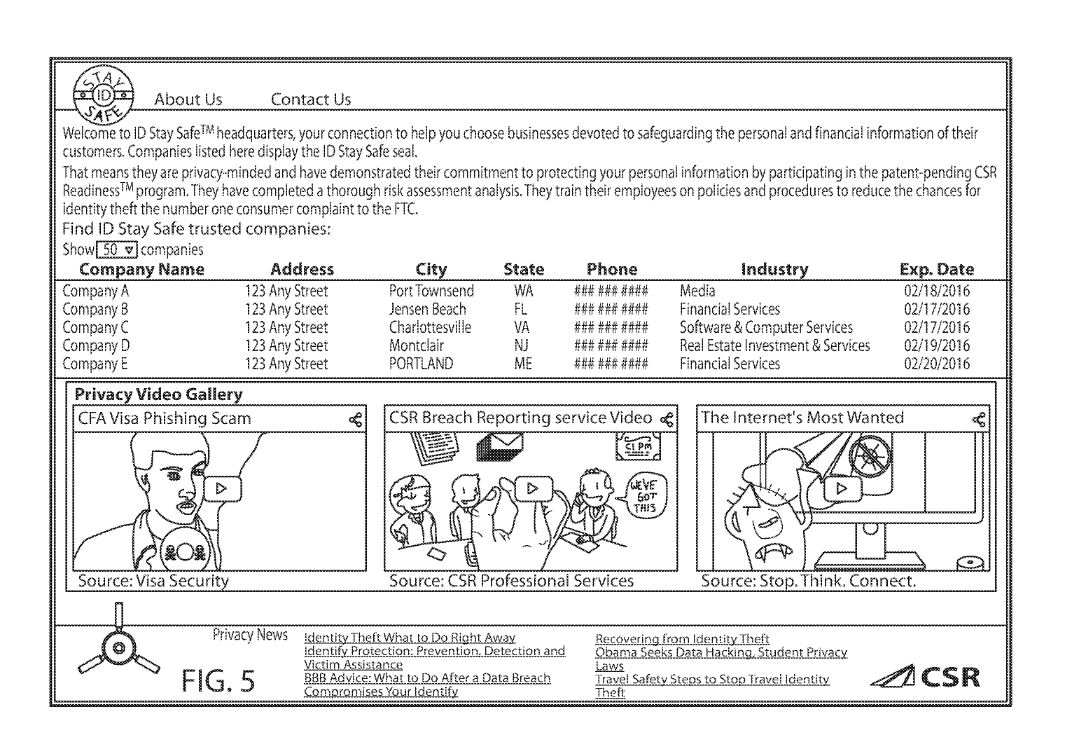

In accordance with one aspect of the present invention, the so-called “white list” will be publicly available via a website and provides a trusted source for privacy-minded B2B. Businesses who desire to work with other businesses that have received the Readiness certification of completion will be enabled to identify such businesses. An exemplar of the website containing a sample “white list” of compliant companies is shown in FIG. 5.

The website allows users to search for businesses based on keyword and results will be presented based on a number of factors. Some factors that determine placement are:

1. Ad purchasing

2. Business account level

3. Amount of time a business has been using Readiness

Sixty days prior to certificate expiration, an email is sent to the end user notifying them of their need to recertify.

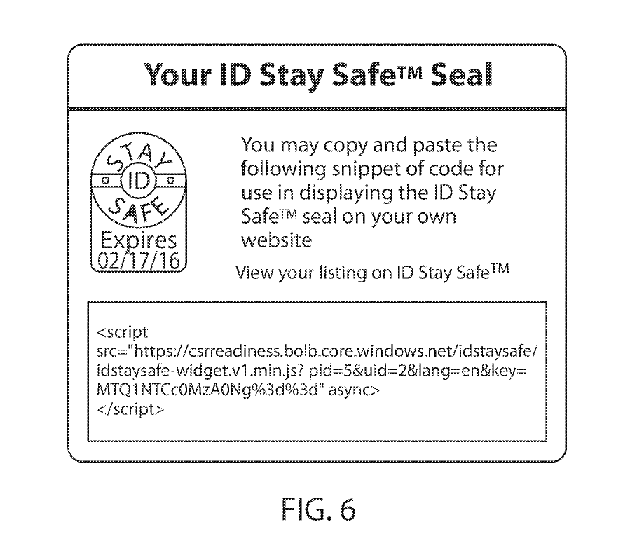

In accordance with one aspect of the invention, an end-user can be given a segment of code. This segment of code can be embedded in the commercial website of the end user, linking readers of the end user's website to the website containing the “white list” showing the compliance and readiness of the end user company. An exemplar of the graphical appearance of the widget is shown in FIG. 6.

1. A system for data breach readiness comprising: a processor and a non-volatile storage medium comprising:
a) code for presenting a questionnaire relating to data security practices;
b) code for grading the answers to the questionnaire to determine a readiness score;
c) code for presenting a task list comprising a list of tasks to be accomplished before a thresh hold readiness score is achieved; and
d) code for presenting a user interface to update the task list to show that an entry in the task list has been completed.

2. The system of claim 1, further comprising code for customizing the questionnaire.

3. The system of claim 2, further comprising code for creating a first question, a second question, and a third question for the questionnaire, wherein the second question or the third question is presented depending on the answer to the first question.

4. The system of claim 1, further comprising code for adding an option to purchase services to the task list.

5. The system of claim 1, further comprising code for adding a user to a list of compliant companies, and code for displaying a list of compliant companies.

6. The system of claim 1, further comprising code for using the answers to the questionnaire to predict the likelihood of a data breach.
